(19) United States
(12) Patent Application Publication
(10) Pub. No.: US 2010/0058599 A1
(43) Pub. Date: Mar. 11, 2010

(54) True elevation grade tape

(76) Inventor: Lee Edgar Sartain, Clearwater, FL (US)

Correspondence Address: Lee Edgar Sartain, # 1802, 3780 University Club Blvd., Jacksonville, FL, 32277, US

(21) Appl. No.: 12/006,372

(22) Filed: Mar. 21, 2008

(51) Int. Cl. G01C 15/02

(52) U.S. Cl. 33/293; 33/758

(57) ABSTRACT

A leveling rod on adhesive tape and a method of surveying are disclosed. A leveling rod on adhesive tape imprinted with a standardized increment of measure including metric, U.S. units, engineering scale or other increment of linear measure and imprint it in a fashion common to leveling rods on an adhesive tape or label preferably in a descending scale or other format for example ascending scale, or a scale defined as cut fill. TRUE ELEVATION GRADE TAPE could then be applied to any object of interest. After a few mathematical calculations to determine your instrument height you would place at that height, the corresponding gradient imprinted on the TRUE ELEVATION GRADE TAPE on the object of interest and when viewed with any telescopic instrument i.e. a builders level, you could determine the exact elevation of the object of interest. Or any change thereof.

### BACKGROUND OF INVENTION IS IN CONSTRUCTION

True Elevation Grade Tape will be used as a leveling rod to establish linear elevation in building construction ref. 33/403,33/758, and 33/293

### BRIEF SUMMARY OF MY INVENTION

A leveling rod on adhesive tape and a method of surveying are disclosed. A leveling rod on adhesive tape imprinted with a standardized increment of measure including metric, U.S. units, engineering scale or other increment of linear measure and imprint it in a fashion common to leveling rods on an adhesive tape or label preferably in a descending scale or other format for example ascending scale, or a scale defined as cut fill. TRUE ELEVATION GRADE TAPE could then be applied to any object of interest. After a few mathematical calculations to determine your instrument height you would place at that height, the corresponding gradient imprinted on the TRUE ELEVATION GRADE TAPE on the object of interest and when viewed with any telescopic instrument i.e. a builder's level, you could determine the exact elevation of the object of interest. Or any change thereof.

### BRIEF EXPLANATION OF DRAWINGS

And method or system of surveying

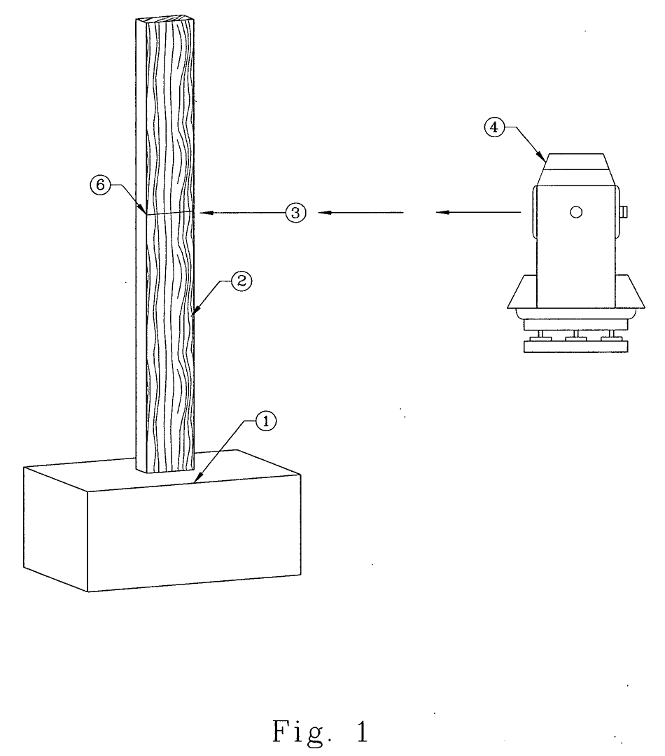

In FIG. 1 A 2″×4″ or temporary rod is set on a predetermined bench mark of 8′-0″ navigational and the laser instrument height is marked on a temporary rod.

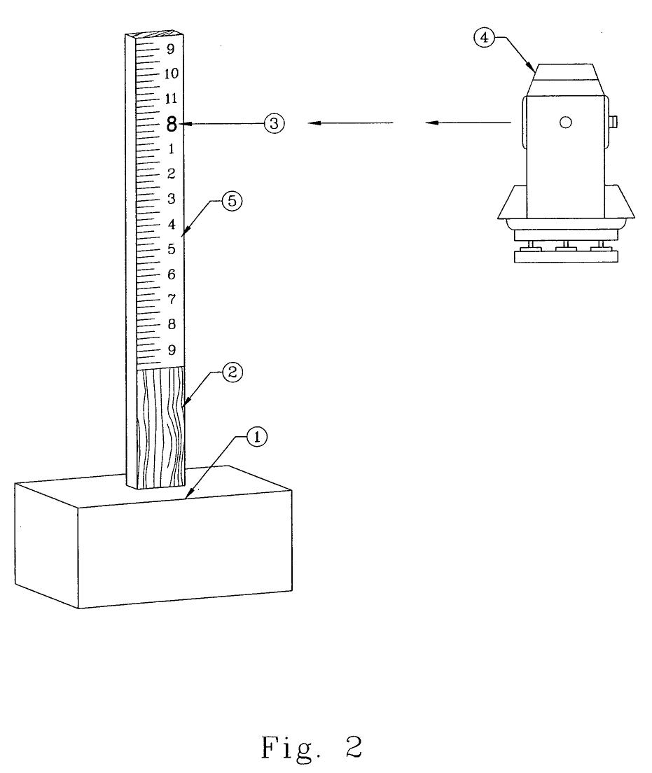

In FIG. 2 the bench mark value, or 8′-0″ is located on the GRADE TAPE and have attached it to a temporary rod or 2″×4″ at the mark representing the instruments height.

In FIG. 2 Notice GRADE TAPE with a descending value in feet and inches is now attached to temporary rod at instrument height as we prepair to establish navigational elevation.

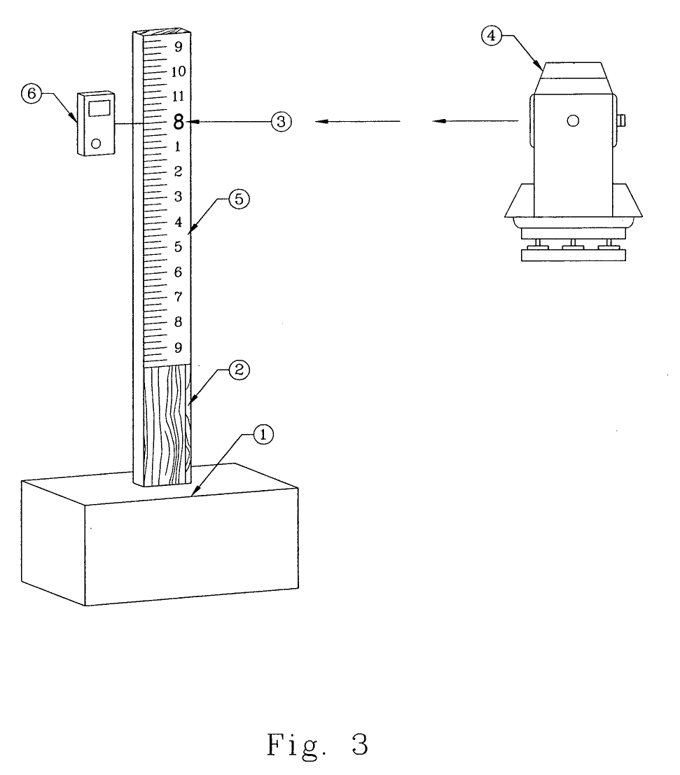

In FIG. 3 the lasers target is now re attached near elevation 8′-0″. The rod is ready, wherever you place the target on this temporary rod the bottom of the rod will be at the elevation indicated at the target, no additional math required thus reducing the possible error!

In FIG. 1 In order to establish elevations below finished floor. A 2″×4″ or temporary rod is placed on a predetermined benchmark identified as finished floor and the laser instruments height is marked on the rod.

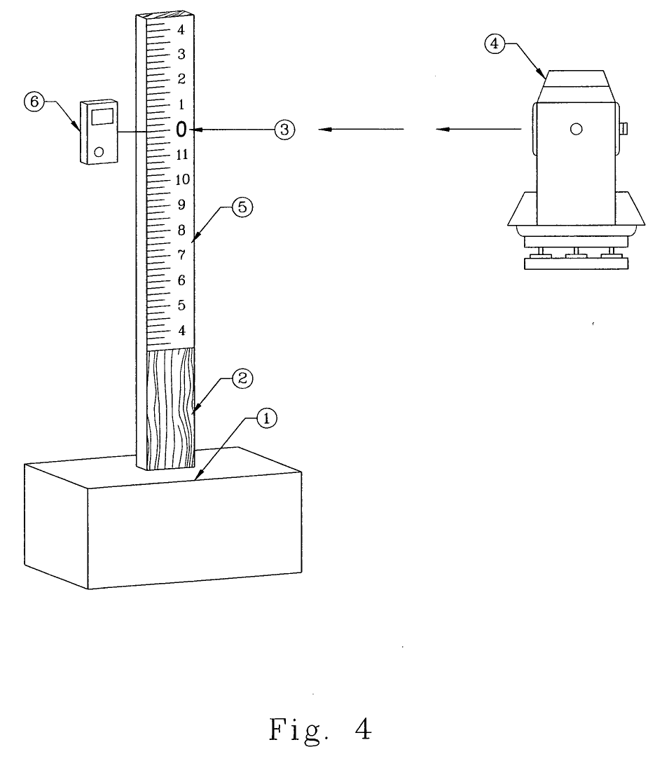

In FIG. 4 Notice GRADE TAPE with an ascending value in feet and inches has been attached to the temporary rod, placing the 0′-0″ indicator at the instrument height mark on the rod. Bear in mind if you move the target up the rod the bottom of the rod goes down; to locate elevation −2′-0″ you simply move the target up the rod to the 2′-0″ indicator. Now as the target is realigned with the laser instrument the bottom of the rod will indicate −2′-0″ below finished floor with no further mathematical calculations.

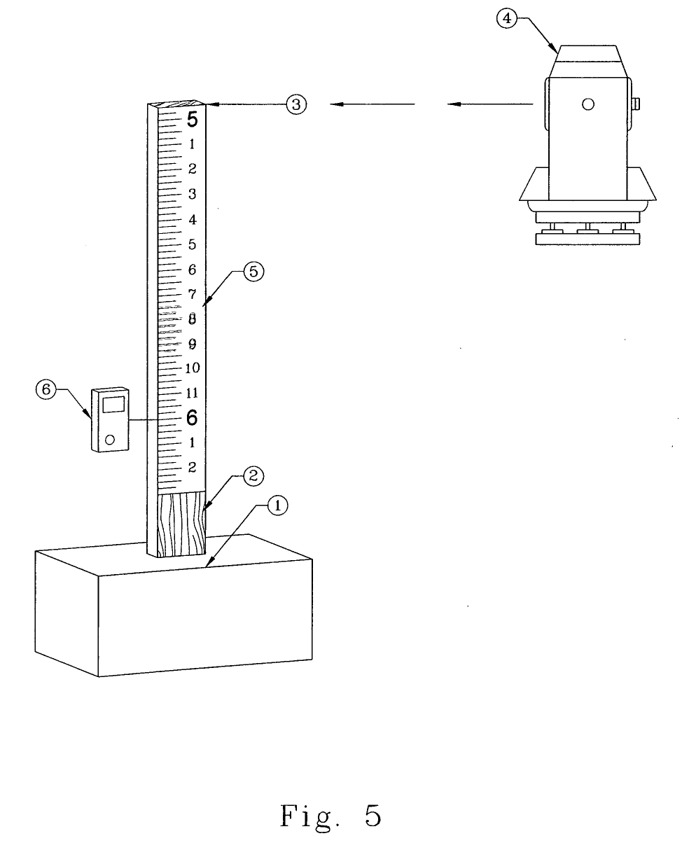

In FIG. 5 In order to establish elevations above the instrument, this method has been developed to set elevations of soffits, headers, windows, and other architectural elevations. Using GRADE TAPE with an descending value in feet and inches we have determined the instrument height and attached that value to the top of the rod and extended GRADE TAPE downward, the rod is now ready at whatever point you set the target, as it is realigned with the laser the top of the rod will reflect the height above finished floor as reflected at the location of the target, no further mathematical calculations required.

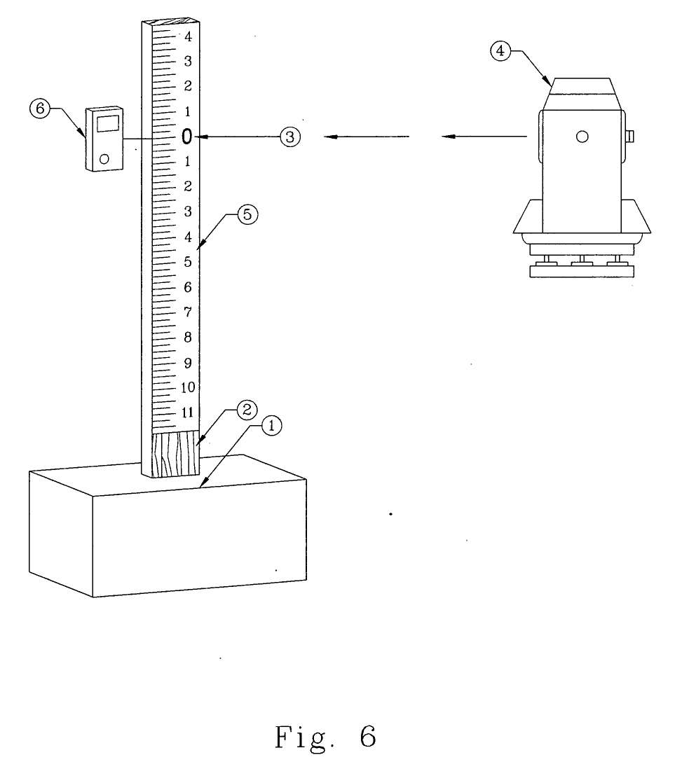

In FIG. 6 GRADE TAPE has been set at a predetermined bench mark with the 0′-0″ indicator set at the instrument height. The GRADE TAPE format required for this operation has an ascending linear value above the 0′ feet mark and descending below the 0′-0″ mark using a floating target or optical level you could determined the amount above or below the desired elevation an object of interest is.

Finally these illustrations are not meant to limit the methods of use for the utility of design.

1. A leveling rod on adhesive tape, comprising; an elongated single or multi layer adhesive strip or laminate having a front side and a backside. said leveling rod on adhesive tape printed on the front side with any standardized increment of linear measure in a fashion common to leveling rods, with an ascending lineal measure format, descending lineal measure format, or a cut fill lineal measure format that would ascend in value above a point of 0′ feet and descend in value beneath said point; said leveling rod on adhesive tape, coated on the backside with an pressure sensitive adhesive coating;

2. A method of surveying utilizing the leveling rod on adhesive tape described in claim #1. Whereas a surveyor would use the leveling rod on adhesive tape described in claim, #1 with the linear measure format required for the task ahead as determined by civil, structural, architectural, or other engineered drawing or information, as each art may use a different format; For instance for navigational elevations the surveyor would use the leveling rod on adhesive tape with a linear measurement format of descending value as described in claim #1 as follows;

A. The surveyor would set up an optical level or laser.

B. The surveyor would locate an established benchmark.

C. The surveyor would place the bottom of a length of 2″×4″, PVC pipe, or other temporary rod on said benchmark.

D. The surveyor would then view and mark said temporary rod at the instrument height

E. The surveyor would determine the benchmark elevation value, locate that value on the leveling rod on adhesive tape described in claim #1, and attach that value at the instrument height mark on said temporary rod using the adhesive back side then extending the leveling rod on adhesive tape as mentioned in claim #1 in each direction as required.

F. The surveyor would on any subsequent relocation of said leveling rod, be able to read with said optical level or laser upon relocating the lasers target, the correct elevation of the bottom of the said leveling rod without further mathematical calculations. Providing the optical level or laser has remained undisturbed.

3. A method of surveying utilizing the leveling rod on adhesive tape as described in claim #1. Whereas a surveyor would use the leveling rod on adhesive tape described in claim, #1 with the format required for the task ahead as determined by civil, structural, architectural, or other engineered drawing or information, as each art may use a different format. For instance for structural foundation elevations that are described as being a particular distance below finished floor or benchmark of 0.00 or FF. the surveyor would use the leveling rod on adhesive tape described in claim #1 with an ascending linear measure as follows;

A. The surveyor would set up an optical level or laser.

B. The surveyor would locate an established benchmark.

C. The surveyor would place a length of 2″×4″, PVC pipe, or other temporary rod on said benchmark.

D. The surveyor would then view and mark said temporary rod at the instrument height.

E. The surveyor would locate the 0′ feet of linear measure value on the leveling rod on adhesive tape described in claim #1 and attach said value at the instrument height mark on said temporary rod using the adhesive back side then extending the leveling rod on adhesive tape of claim #1 in each direction as required.

F. The surveyor would on each consecutive relocation of said temporary leveling rod on which is applied the leveling rod on adhesive tape as described in claim #1 upon viewing through the optical level or relocating the lasers target, would be reading the correct distance from finished floor to the bottom of said temporary rod as now located without having to make additional mathematical calculations. Providing the optical level or laser has not been disturbed.

4. A method of surveying utilizing the leveling rod on adhesive tape as described in claim #1. Whereas a surveyor would use the leveling rod on adhesive tape of claim, #1 with the format required for the task ahead as determined by civil, structural, architectural, or other engineered drawing or information, as each art may use a different format. For instance, for architectural interior elevations the surveyor would use the leveling rod on adhesive tape with a linear measure of descending format described in claim #1 as follows;

A. The surveyor would set up an optical level or laser.

B. The surveyor would locate an established benchmark indicating finished floor.

C. The surveyor would place a length of 2″×4″, PVC pipe, or other temporary rod on the benchmark.

D. The surveyor would then view and mark said temporary rod at the instrument height to determining the instrument height above finish floor.

E. The surveyor would determine the instrument height above finished floor and locate that value on the leveling rod on adhesive tape described in claim #1 printed with an increment of standardized linear measure with an descending value as described in claim #1, and attach that value from the top of said temporary rod and downward for a length as required using the adhesive back side, extending the leveling rod on adhesive tape as described in claim #1 as required.

F. The surveyor upon any subsequent relocation of said leveling rod would while viewing through the instrument or relocating the lasers target would be reading the correct elevation of the top of the rod without further mathematical calculations. Providing the optical level or laser has remained undisturbed.

I claim:

1. A leveling rod on adhesive tape, comprising; an elongated single or multi layer adhesive strip or laminate having a front side and a backside;
said leveling rod on adhesive tape printed on the front side with any standardized increment of linear measure in a fashion common to leveling rods, with an ascending lineal measure format, descending lineal measure format, or a cut fill lineal measure format that would ascend in value above a point of 0′ feet and descend in value beneath said point;
said leveling rod on adhesive tape, coated on the backside with an pressure sensitive adhesive coating;

2. A method of surveying utilizing the leveling rod on adhesive tape described in claim #1. Whereas a surveyor would use the leveling rod on adhesive tape described in claim, #1 with the linear measure format required for the task ahead as determined by civil, structural, architectural, or other engineered drawing or information, as each art may use a different format; For instance for navigational elevations the surveyor would use the leveling rod on adhesive tape with a linear measurement format of descending value as described in claim #1 as follows;
A. The surveyor would set up an optical level or laser.
B. The surveyor would locate an established benchmark.
C. The surveyor would place the bottom of a length of 2″×4″, PVC pipe, or other temporary rod on said benchmark.
D. The surveyor would then view and mark said temporary rod at the instrument height
E. The surveyor would determine the benchmark elevation value, locate that value on the leveling rod on adhesive tape described in claim #1, and attach that value at the instrument height mark on said temporary rod using the adhesive back side then extending the leveling rod on adhesive tape as mentioned in claim #1 in each direction as required.
F. The surveyor would on any subsequent relocation of said leveling rod, be able to read with said optical level or laser upon relocating the lasers target, the correct elevation of the bottom of the said leveling rod without further mathematical calculations. Providing the optical level or laser has remained undisturbed.

3. A method of surveying utilizing the leveling rod on adhesive tape as described in claim #1. Whereas a surveyor would use the leveling rod on adhesive tape described in claim, #1 with the format required for the task ahead as determined by civil, structural, architectural, or other engineered drawing or information, as each art may use a different format. For instance for structural foundation elevations that are described as being a particular distance below finished floor or benchmark of 0.00 or FF. the surveyor would use the leveling rod on adhesive tape described in claim #1 with an ascending linear measure as follows;
A. The surveyor would set up an optical level or laser.
B. The surveyor would locate an established benchmark.
C. The surveyor would place a length of 2″×4″, PVC pipe, or other temporary rod on said benchmark.
D. The surveyor would then view and mark said temporary rod at the instrument height.
E. The surveyor would locate the 0′ feet of linear measure value on the leveling rod on adhesive tape described in claim #1 and attach said value at the instrument height mark on said temporary rod using the adhesive back side then extending the leveling rod on adhesive tape of claim #1 in each direction as required.
F. The surveyor would on each consecutive relocation of said temporary leveling rod on which is applied the leveling rod on adhesive tape as described in claim #1 upon viewing through the optical level or relocating the lasers target, would be reading the correct distance from finished floor to the bottom of said temporary rod as now located without having to make additional mathematical calculations. Providing the optical level or laser has not been disturbed.

4. A method of surveying utilizing the leveling rod on adhesive tape as described in claim #1. Whereas a surveyor would use the leveling rod on adhesive tape of claim, #1 with the format required for the task ahead as determined by civil, structural, architectural, or other engineered drawing or information, as each art may use a different format. For instance, for architectural interior elevations the surveyor would use the leveling rod on adhesive tape with a linear measure of descending format described in claim #1 as follows;
A. The surveyor would set up an optical level or laser.
B. The surveyor would locate an established benchmark indicating finished floor.
C. The surveyor would place a length of 2″×4″, PVC pipe, or other temporary rod on the benchmark.
D. The surveyor would then view and mark said temporary rod at the instrument height to determining the instrument height above finish floor.
E. The surveyor would determine the instrument height above finished floor and locate that value on the leveling rod on adhesive tape described in claim #1 printed with an increment of standardized linear measure with an descending value as described in claim #1, and attach that value from the top of said temporary rod and downward for a length as required using the adhesive back side, extending the leveling rod on adhesive tape as described in claim #1 as required.
F. The surveyor upon any subsequent relocation of said leveling rod would while viewing through the instrument or relocating the lasers target would be reading the correct elevation of the top of the rod without further mathematical calculations. Providing the optical level or laser has remained undisturbed.
